(19) United States
(12) Patent Application Publication
(10) Pub. No.: US 2005/0108306 A1
(43) Pub. Date: May 19, 2005

(54) Logic formulator

(76) Inventor: Peter Paul Martizano Catalasan, Harbor City, CA (US)

Correspondence Address: Peter Paul Catalasan, 25410 Dodge Ave, # K, Harbor City, CA, 90710, US

(21) Appl. No.: 11/005,581

(22) Filed: Dec. 7, 2004

Related U.S. Application Data
(63) Continuation of application No. 10/074,933, filed on May 16, 2002, now abandoned.

(51) Int. Cl. G06F 3/00

(52) U.S. Cl. 708/160

(57) ABSTRACT

Historically, mathematicians and scientists have never really defined creativity, and more importantly, Mathematical Creativity. My novel discovery introduces the precise definition and system architecture of a new Artificial Intelligence paradigm that conforms to Strong AI claims with Artificial Neural Networks, called Logic Formulators. Not only does it encompass automated programming, but design as well, since its manipulation creates New Objects from many Different Mathematical Objects.

### TABLE OF CONTENTS

I. Field of Invention
II. Summary of Invention
III. System Drawings
IV. Brief Description of Drawings
V. Description of the Preferred Embodiments

### I. FIELD OF INVENTION

What is Creativity? How does a computer simulate or even obtain creativity, the Strong AI? Here, I claim that Creativity is Strong AI. Since by the Webster's New World Dictionary and Thesaurus, Creativity is defined to be “causing to come into being, make or originate, to bring about, to give rise to, or cause,” means that Creativity belongs to high level processes only available to programmers and designers; however, until now! I have discovered the process and definition of Mathematical Creativity and continued to refine its System Architecture to actually and precisely define it to be, “Mathematical Creativity through the Application of Chaotic-Logic Generators between Two Distinct Mathematical Objects Using an Artificial Neural Network,” the Field of Artificial Intelligence Research.

### II. SUMMARY OF INVENTION

Using mathematical logic and computer science implementation techniques, I have made progress to create machines that formulate logic on its own, called, logic formulators; they are no longer computers but are the very next computer revolution. Discovering this new breakthrough in True Creative Machines, where these formulators actually generate new mathematical relationships independent of outside human intervention, develops a beginning point to the True Next Computer Revolution.

I will now explain my logic formulator with an easy example, Analytic Geometry. How did Descartes create Analytic Geometry, new mathematics at that time? Well, he started with Two Old Distinct Mathematical Objects, namely Algebra and Geometry, and compared and contrasted the Two Objects by dividing each object into separate Components and chaotically mixing and matching each component with each other, but creating a relationship or “logic connector” between each Component. For example, X²+Y²=R², has a mathematical-logical-relationship, MLR, to a Geometric Circle, thus, producing Analytic Geometry!

### III. SYSTEM DRAWINGS

Please see Drawing Pages.

### IV. BRIEF DESCRIPTION OF DRAWINGS

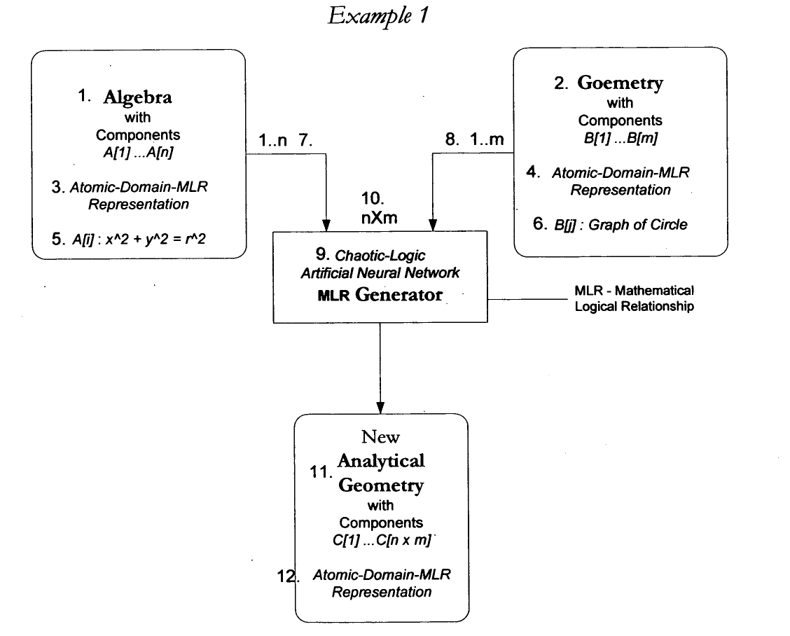

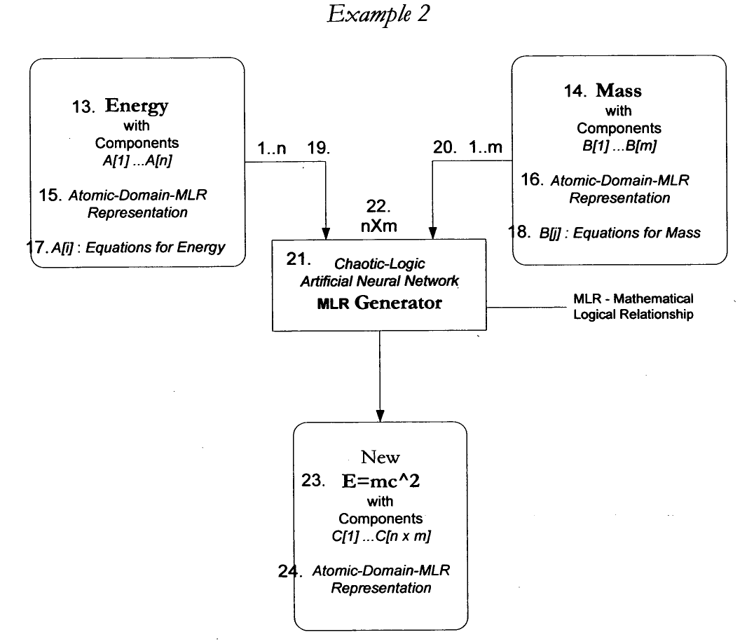

The Mathematical Creativity System Model—Example 1, Drawing 1, is an example of Generating New Mathematics. Algebra, FIG. 1, has independent components, A[i], such as x²+y²=r², FIG. 5, represented using an Atomic-Domain-Mathematical Logical Relationship, FIG. 3. Similarly, Geometry, FIG. 2, has independent components, B[j] such as a Graph of a Circle, FIG. 6, represented using an Atomic-Domain-Mathematical Logical Relationship, FIG. 4. Take one component from 1 . . . n, FIG. 7, of Geometry and take one component from 1 . . . m, FIG. 8, of Algebra, creating a MLR or Mathematical Logical Relationship, FIG. 9, repeating this for all n X m, FIG. 10, produces New Mathematics, Analytic Geometry, FIG. 11, with components C[1] . . . C[n×m] represented in Atomic-Domain-MLR, FIG. 12.

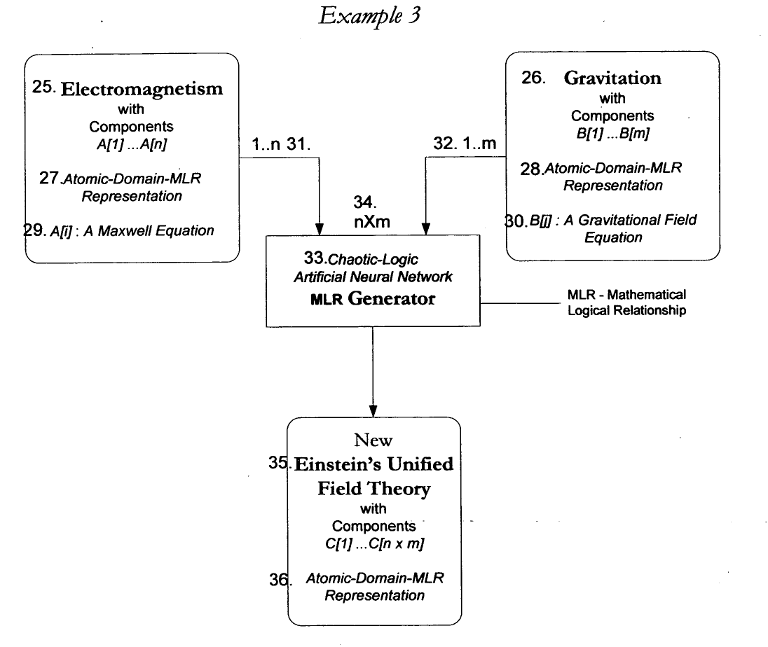

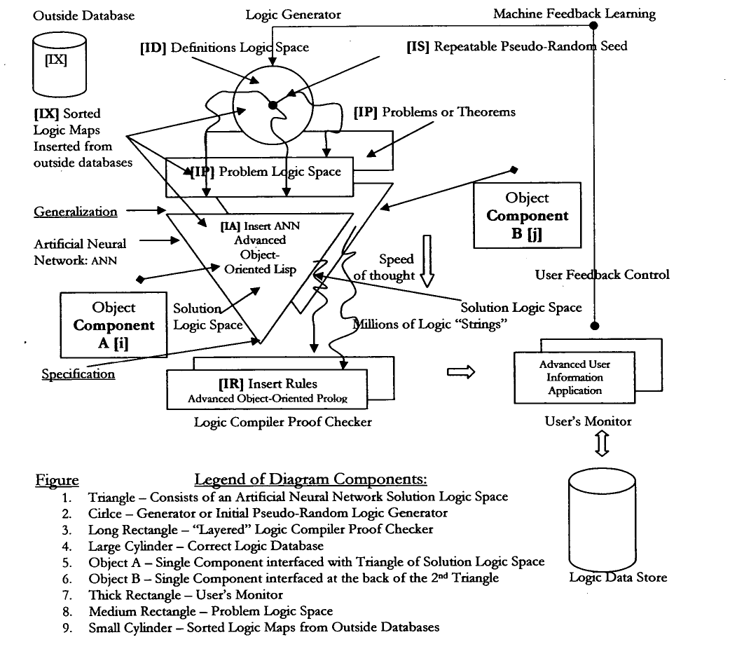

The Mathematical Creativity System Model—Example 2, Drawing 2, is an example of Finding and Simplifying New Mathematical Relationships. Energy, FIG. 13, has independent components, A[i], such as the Equations for Energy, FIG. 17, represented using an Atomic-Domain-Mathematical Logical Relationship, FIG. 15. Similarly, Mass, FIG. 2, has independent components, B[j], such as the Equations for Mass, FIG. 18, represented using an Atomic-Domain-Mathematical Logical Relationship, FIG. 16. Take one component from 1 . . . n, FIG. 19, of Energy and take one component from 1 . . . m, FIG. 20, of Mass, creating a MLR or Mathematical Logical Relationship, FIG. 21, simplifying by means of Algebraic Rules using Computational Mathematical Techniques for all n×m, FIG. 22, produces a Simplified Object, E=mc², FIG. 23, with components C[1] . . . C[n×m] represented in Atomic-Domain-MLR, FIG. 24.

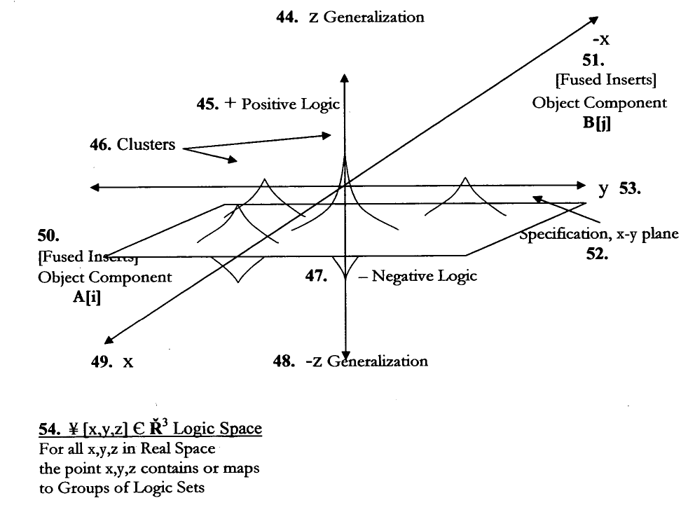

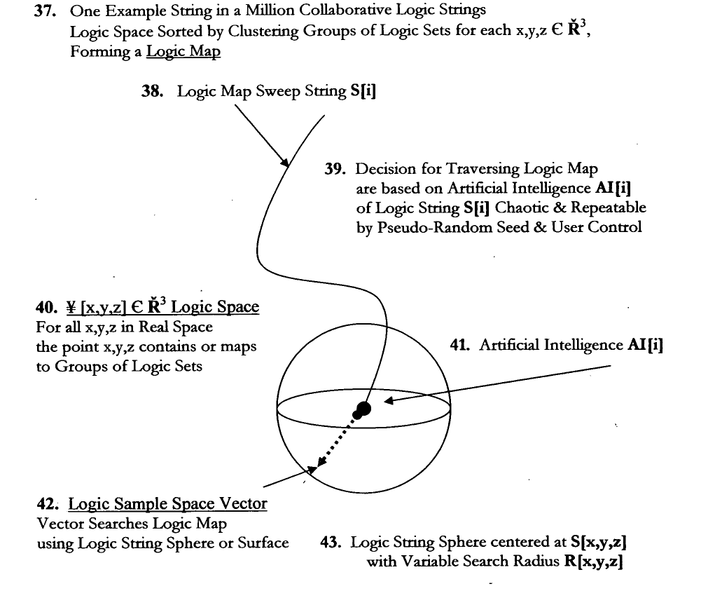

The Mathematical Creativity System Model—Example 3, Drawing 3, is an example of finding Einstein's Unified Field Theory. Electromagnetism, FIG. 25, has independent components, A[i], such as one of Maxwell's Electromagnetic Equation, FIG. 29, represented using an Atomic-Domain-Mathematical Logical Relationship, FIG. 27. Similarly, Gravitation, FIG. 26, has independent components, B[j], such as one of Newton's Gravitational Field Equation, FIG. 30, represented using an Atomic-Domain-Mathematical Logical Relationship, FIG. 28. Take one component from 1 . . . n, FIG. 31, of Electromagnetism and take one component from 1 . . . m, FIG. 32, of Gravitation, creating a MLR or Mathematical Logical Relationship, FIG. 33, repeating this for all n X m, FIG. 34, produces Einstein's Unified Field Theory, FIG. 35, with components C[1] . . . C[n×m] represented in Atomic-Domain-MLR, FIG. 36.

The Legend of Diagram Components maps the component to FIGS. 1 . . . 9 of the Chaotic-Logic Artificial Neural Network MLR (Mathematical Logical Relationship) Generator presented, in Drawing 4, that is responsible for formulating logic between two components A[i] and B[j] using many collaborative logic strings traversing the Definitions Space, FIG. 2, Problem Logic Space, FIG. 8, Solution Logic Space, FIG. 1, and lastly the Logic Compiler Proof Checker, FIG. 3, giving the Correct MLR to the User's Monitor, FIG. 7 for User Control and Feedback Machine Learning.

The Logic Generator, FIG. 2, produces, by Pseudo-Random Seed and Definitions, initial logic for use in passing through the Problem Logic Space, FIG. 8, acquiring the problem or theorem to be solved, and chaotically finding the correct mathematical logical relationship when it enters the Solution Logic Space, FIG. 1. Given inserts of Logical Procedural Implications and Groups of Logic Sets with variables in the Solution Logic Space, FIG. 8, the most important feature uses a Clustered Logic Map Solution Space, Drawing 5, to map an Object A[i] component, Drawing 4, FIG. 5, and Object B[j] component, FIG. 6, forming a solution logic space map, where Logic Strings chaotically pass through it, and once it has established this, the Layered Logic Compiler proof checker, FIG. 3, checks the Logic String then passes the Correct Logic to the User's Monitor, FIG. 7, and into the Correct Logic Database, FIG. 4, upon which the user and logic information is fed back to the Generator for Machine Learning.

The Generalized Logic Space Sweep String S[i], Drawing 6, FIG. 38, with the ability of message collaboration, FIG. 37, is an example of Logic Strings passing through a generalized logic space, sorted by clustering Groups of Logic Sets forming a Logic Map, such that for all [x,y,z]ε\check{R}³ in Real Space, FIG. 40, the point x,y,z maps to Groups of Logic Sets. The Logic Sample Vector, FIG. 42, searches the Logic Map with the extent of the radius of a sphere centered at S[x,y,z] and its surface with variable search radius R[x,y,z], FIG. 43. The decision, FIG. 39, to move through the generalized logic space is done through the content of the Logic Sample Vector, Mathematical Logical Relationship Memory, other Strings, Predefined User Control, and Pseudo-Random Seed for repeatability, and an Artificial Neural Network Schema, FIG. 41, generalized to be true for all Logic Space mentioned.

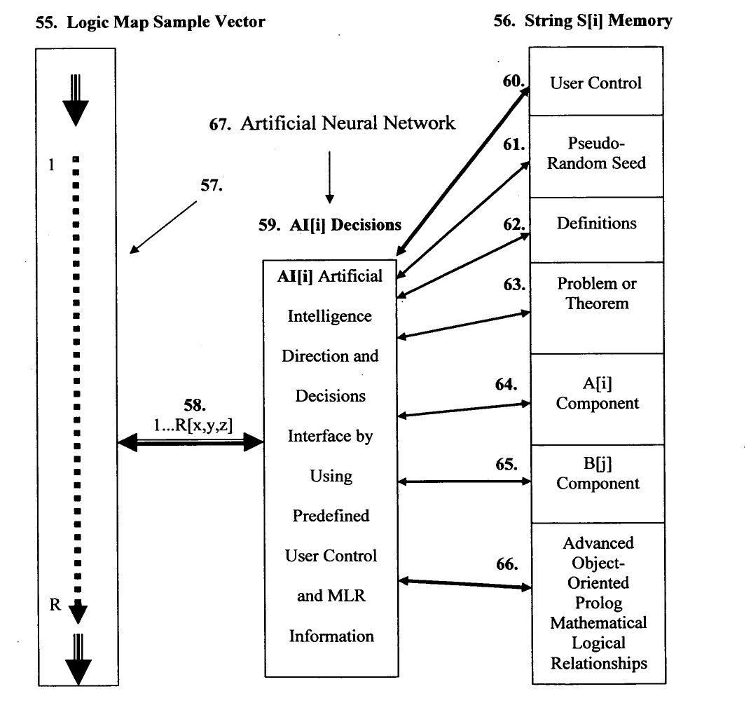

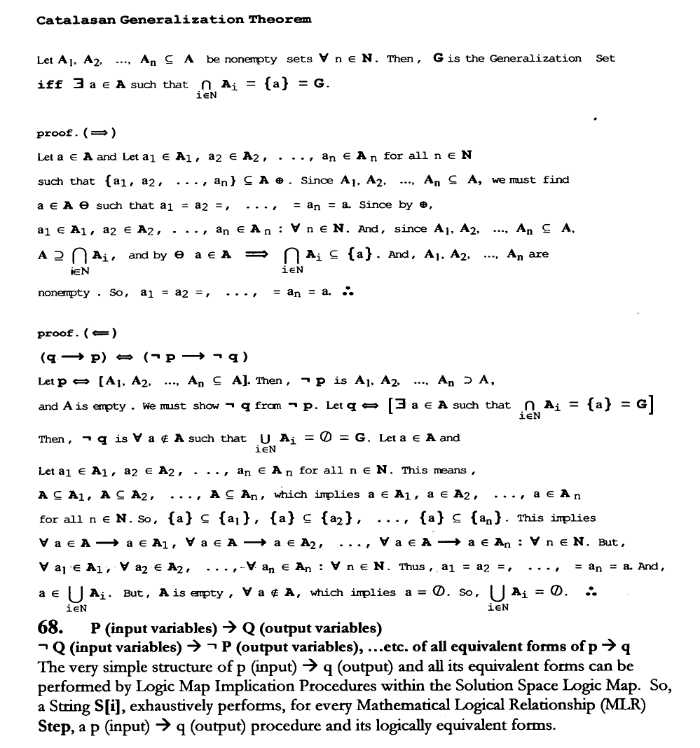

The Clustered Logic Map Solution Space, Drawing 5, shows a three-dimensional rendition of clustered and generalized positive and negative logic with fused logic inserts of one component A[i] and one component B[j], where the three-dimensional coordinates are, respectively, generalizations for Z, FIG. 44 & FIG. 48, fused components for X, FIG. 49, and infinity for Y, FIG. 53, such that for all x,y,z in Real Space, FIG. 54, the point x,y,z contains or maps to Groups of Logic Sets, where the Logic Strings S[i] traverses the Logic Space forming mathematical logical relationships between the two object components A[i], FIG. 50, and B[j], FIG. 51. Negative Logic, FIG. 47, mirrors the Positive Logic, FIG. 45, clustering the Logic, FIG. 46, with its peaks as generalizations, and the x-y plane as specifications, FIG. 52.

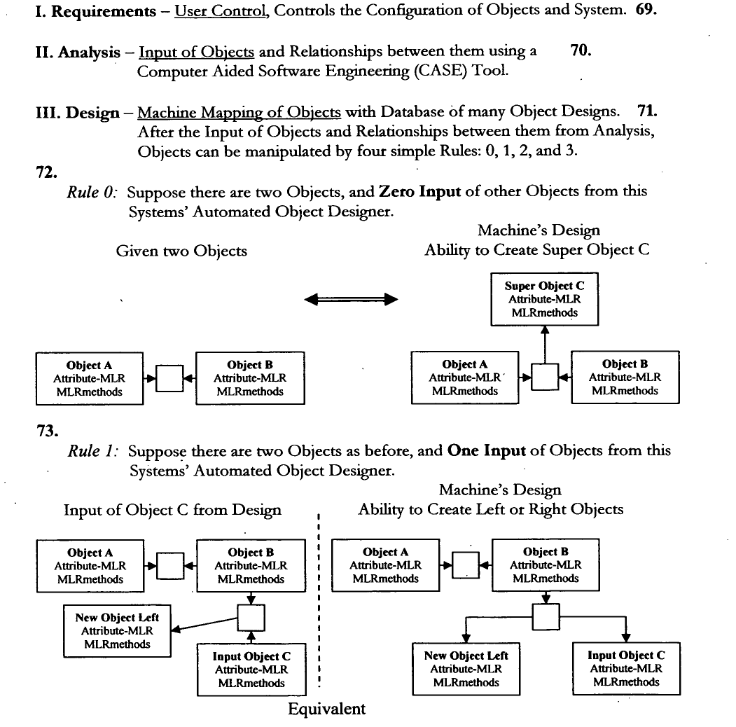

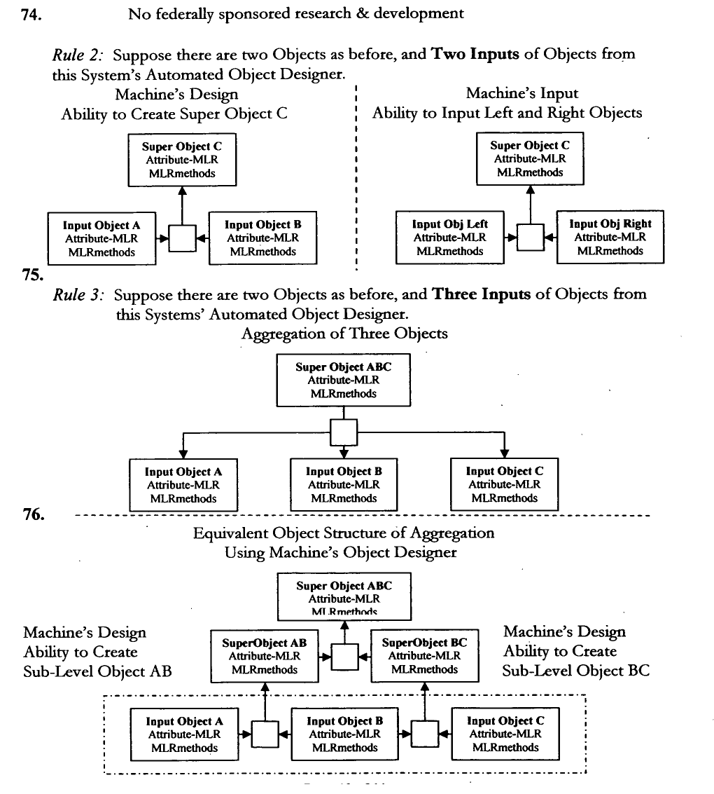

The Advanced Object-Oriented Common Lisp Logic Strings, Drawing 7, explains the relationship between the Logic Map Sample Vector, FIG. 55, with length R in one-dimensional Real Space, FIG. 57, for the position x,y,z in the Solution Logic Space, FIG. 58. The AI[i] Decisions, FIG. 59, direct the movement of the String S[i] in the Solution Logic Space, using an Artificial Neural Network Schema, FIG. 67, and information from String S[i] Memory, FIG. 56, that contains the User Control, FIG. 60, Pseudo-Random Seed, FIG. 61, Definitions, FIG. 62, Problem or Theorem, FIG. 63, A[i] component, FIG. 64, B[j] component, FIG. 65, and Mathematical Logical Relationships, FIG. 66, such that the language is an Advanced Object-Oriented Common Lisp construct, but the Mathematical Logical Relationship, FIG. 66, an Advanced Object-Oriented Prolog construct.

Included is the Catalasan Generalization Theorem, in Drawing 8, for the purpose of the mathematical understanding of generalizations and specifications for the Solution Logic Space, and to explain how this system can function as an example. FIG. 68, states the notion of p implies q, or p→q, that the implication is a logical procedure sorted as a point x,y,z, in the Clustered Logic Map Solution Space, Drawing 5, so that p (input variables)→q (output variables) happen for every notion of a proof, and all its equivalent forms, such as the contrapositive, [symbol] q (input variables)→ [symbol] p (output variables), and is the Group of Equivalent Logic Sets mentioned above.

As an example, Drawing 8, in the Catalasan Generalization Theorem, there are two objects: (A₁ . . . Aₙ such that they are subsets of A, for all n belonging to N) and (there exists a belonging to A such that all the Intersections (A₁ . . . Aₙ)={a}). Given these two objects, we must find the mathematical logical relationships between them, and since the Clustered Logic Map Solution Space, Drawing 5, contains implication procedures, and we have all the variables for inputs and outputs of implications, this logic formulator will find, through the Chaotic-Logic Artificial Neural Network MLR Generator, Drawing 4, the necessary mathematical logical relationships solution.

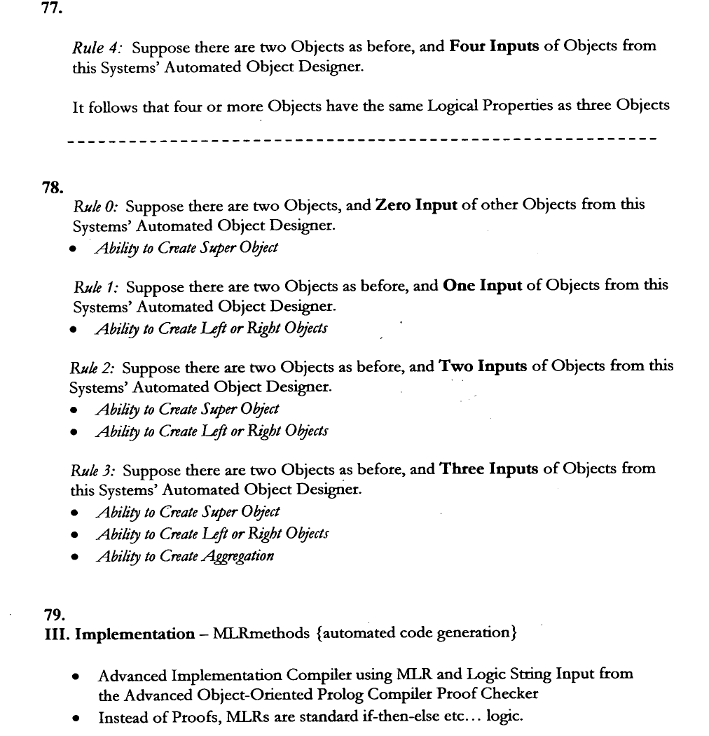

The Software Engineering Creativity System Structure, where the position of this logic formulator applies to real world applications is stated in Drawings 9, 10, and 11. The Requirements, FIG. 69, is the User's attempt to control the system through definitions which would control the structure of objects, not as the usual ad hoc requirements definition, but a generalized mathematical schema for the structural control of objects. In the Analysis, FIG. 70, the User inputs Objects and Relationships using an Advanced Computer Aided Software Engineering (CASE) Tool. The Design, FIG. 71, is the most complex. However, there are four explicit rules as to the Automated Object Designer's will in creating an object design specified by the Requirements and Analysis: Rule 0, FIG. 72, has the ability to create a Super Object C; Rule 1, FIG. 73, has the ability to create a Left or Right Object; Rule 2, FIG. 74, has the ability to create a Super Object C, and a Left or Right Object; Rule 3, FIG. 75, has the ability to create an Aggregation Object ABC, FIG. 76, and a Super Object, and a Left or Right Object; Rule 4, FIG. 77, has the same properties as Rule 3, summarized in FIG. 78. And, lastly, the Implementation, FIG. 79, automates code generation through an Advanced Compiler that translates MLRs and Logic Strings into standard if-then-else logic.

### V. DESCRIPTION OF PREFERRED EMBODIMENTS

The Mathematical Creativity System Model—Example 1, Drawing 1, provides an example of Generating New Mathematics. Algebra, FIG. 1, has independent components, A[i], such as x²+y²=r², FIG. 5, represented using an Atomic-Domain-Mathematical Logical Relationship, FIG. 3. Similarly, Geometry, FIG. 2, has independent components, B[j] such as a Graph of a Circle, FIG. 6, represented in an Atomic-Domain-Mathematical Logical Relationship, FIG. 4. Take one component from 1 . . . n, FIG. 7, of Geometry and take one component from 1 . . . m, FIG. 8, of Algebra, connecting MLRs or Mathematical Logical Relationships, FIG. 9, repeating this for all n X m, FIG. 10, produces New Mathematics, Analytic Geometry, FIG. 11, with components C[1] . . . . C[n×m] represented again as an Atomic-Domain-MLR, FIG. 12. The Atomic-Domain-MLR constrains information in a way as to allow the most primitive element as a variable and its corresponding finite domain as a set and portraying the relationships between elements with logical connectives or logic strings, into a linear list of distinct components O[1] . . . O[x] organized as one Object, such that the components separate distinctly and without redundancy.

The Mathematical Object, Algebra, FIG. 1, has distinct components, A[1] . . . A[n] that is described in an Atomic-Domain-MLR Representation, FIG. 3, with an example for one component A[i]: x²+y²=r², FIG. 5, for some value i, n∈N. Given the advent of advanced computers, the whole of the mathematical object Algebra can be represented, and constrained as Atomic-Domain-MLR information. The component A[i]: x²+y²=r², FIG. 5, is equivalent to (equal (plus(times x x)(times y y))(times r r)) such that (set-in-real-domain x y r) tests whether x, y, or r is within the finite Real Domain, and MLRs, like times, plus, or equal, are generalized logic procedures with variable inputs in Lisp. In essence, much of the language of Atomic-Domain-MLR representation is just an implementation of Advanced Object-Oriented Common Lisp constructs.

The Mathematical Object, Geometry, FIG. 2, has distinct components, B[1] . . . B[m] that is described in an Atomic-Domain-MLR representation, FIG. 4, with an example for one component B[j]: Graph of Circle, FIG. 5, for some value j, m∈N. The representation of images consumes very large resources and advanced computational requirements with many visual interpretations. However, similar to visual programming, we construct the Graph of a Circle using an Advanced Object-Oriented Common Lisp integrated development environment, visual object-oriented lisp programming, which can be standardized by the International Standards Organization. In essence, the representation of a Graph of a Circle can be done through an Advanced Object-Oriented Common Lisp visual programming application.

The Chaotic-Logic Artificial Neural Network MLR Generator, FIG. 9, generates a MLR, or Mathematical Logical Relationship, through the use of an Artificial Neural Network Schema shown in Drawing 4. The MLR is Lisp Logic Strings that becomes parsed by a Layered Logic Compiler Proof Checker, FIG. 3, using Rules inserted by the User, separating the correct logic from incorrect logic.

The New Mathematical Object, Analytic Geometry, FIG. 11, has distinct components, C[1] . . . C[p] that is described in an Atomic-Domain-MLR representation, FIG. 12, with an example for one component C[k]: Equation for Graph of Circle, for some value k, p∈N. The logic connection or mathematical logical relationship between the Equation (equal(plus(times x x)(times y y))(times r r)) such that (set-in-real-domain x y r), and the Graph of a Circle (visual two-dimensional axis, per se, and corresponding finite points in two-dimensions, represented in a visual Advanced Object-Oriented Common Lisp Logic String construct), are many correct Logic Strings checked by the Layered Logic Compiler Proof Checker.

The Mathematical Creativity System Model—Example 2, Drawing 2, is an example of Finding and Simplifying New Mathematical Relationships. Energy, FIG. 13, has independent components, A[i], such as the Equations for Energy, FIG. 17, represented using an Atomic-Domain-Mathematical Logical Relationship, FIG. 15. Mass, FIG. 2, has independent components, B[j] such as the Equations for Mass, FIG. 18, represented using an Atomic-Domain-MLR, FIG. 16. Take one component from 1 . . . n, FIG. 19, of Energy and take one component from 1 . . . m, FIG. 20, of Mass, creating a MLR or Mathematical Logical Relationship, FIG. 21, then simplifying by means of Algebraic Rules and Computational Mathematical Techniques for all n×m, FIG. 22, produces a Simplified Object, E=mc², FIG. 23, with components C[1] . . . C[n×m] represented in Atomic-Domain-MLR, FIG. 24. The Computational Mathematical Techniques used by advanced scientific computation software, such as Mathematica, provides automated simplification, and the settings pre-specified by the User.

The Mathematical Object, Energy, FIG. 13, has distinct components, A[1] . . . A[n] that is described in an Atomic-Domain-MLR representation, FIG. 15, with an example for one component A[i]: Equation for Energy, FIG. 17, for some value i, n∈N. The whole of Object Energy can be simplified and sorted into discrete components through advanced Computational Mathematical Techniques, such that it sorts by pre-defined User control, into Atomic-Domain-MLRs and visual representations.

The Mathematical Object, Mass, FIG. 14, has distinct components, B[1] . . . B[m] that is described in an Atomic-Domain-MLR representation, FIG. 16, with an example for one component B[j]: Equation for Mass, FIG. 18, for some value j, m∈N. Again, the whole of Object Mass can be simplified and sorted into discrete components through advanced Computational Mathematical Sorting Techniques with pre-defined User control, and constrained to Atomic-Domain-MLRs and visual representations. Specifically, to accomplish this feat, the application of Set Operations and Advanced Sorting Lisp Techniques can manipulate the Object's structure since each Component A[i], Energy, or B[i], Mass, are list Sets.

The Chaotic-Logic Artificial Neural Network MLR Generator, FIG. 21, generates a Mathematical Logical Relationship, through the use of an Artificial Neural Network Schema shown in Drawing 4. The MLR is Logic String that becomes parsed by a Layered Logic Compiler, FIG. 3, which converts it to a Simplified Equation with MLRs. The process of simplification uses algebraic rules and advanced computational mathematical techniques already in use today, but, being the most difficult, is checking the correct logical simplified Object, E=mc², since results can be new logic. However, one criterion, for a simplified object or component, will be Energy relations on the left side and Mass relations on the right side. Einstein's arrival of the simplified equation, E=mc², derives from Lorentz's Transformation Equations and the Object Input of the properties and nature of Light. Thus, the many different simplified results may not follow directly from well known inputs of Objects.

The New Mathematical Object, Energy and Mass, FIG. 23, has distinct components, C[1] . . . C[p] that is described in an Atomic-Domain-MLR representation, FIG. 24, with an example for one component C[k]: Equation of Energy and Mass, E=mc², for some value k, p∈N. Einstein arrived at this equation not through direct Energy and Mass relations but through different Objects so as to note the volatility of unexpected and undiscovered results.

The Mathematical Creativity System Model—Example 3, Drawing 3, is an example of finding Einstein's Unified Field Theory. Electromagnetism, FIG. 25, has independent components, A[i], such as one of Maxwell's Electromagnetic Equation, FIG. 29, represented using an Atomic-Domain-Mathematical Logical Relationship, FIG. 27. Similarly, Gravitation, FIG. 26, has independent components, B[j] such as one of Newton's Gravitational Field Equation, FIG. 30, represented using an Atomic-Domain-Mathematical Logical Relationship, FIG. 28. Take one component from 1 . . . n, FIG. 31, of Electromagnetism and take one component from 1 . . . m, FIG. 32, of Gravitation, creating a MLR or Mathematical Logical Relationship, FIG. 33, repeating this for all n×m, FIG. 34, produces Einstein's Unified Field Theory, FIG. 35, with components C[1] . . . C[n×m] represented in Atomic-Domain-MLR, FIG. 36. This example shows that this system, not just creating new math as to algebraic manipulation, but also generates logic which makes this system complete for research and development of any application, constrained only within Theoretical Advanced Object-Oriented Common Lisp language expressions.

The Mathematical Object, Electromagnetism, FIG. 25, has distinct components, A[1] . . . A[n] that is described in an Atomic-Domain-MLR representation, FIG. 27, with an example for one component A[i]: a Maxwell Equation, FIG. 29, for some value i, n∈N. The whole of Electromagnetism, a well developed theory, can be used to find Einstein's Unified Field Theory.

The Mathematical Object, Gravitation, FIG. 26, has distinct components, B[1] . . . B[m] that is described in an Atomic-Domain-MLR representation, FIG. 28, with an example for one component B[j]: a Gravitational Field Equation, FIG. 30, for some value j, m∈N. The Theory of Gravity, given Newtonian and Relativistic Mechanics, is incomplete in the realms of physics research for the development of Einstein's Unified Field Theory, but can be built up from divisions of the components of Gravity, so that, even with little information, however very important, the whole of Gravity can be developed through logic formulator application steps.

The Chaotic-Logic Artificial Neural Network MLR Generator, FIG. 33, generates a MLR, through the use of an Artificial Neural Network Schema shown in Drawing 3. The MLR is Logic String that becomes parsed by a Layered Logic Compiler, FIG. 3, Drawing 4, which converts it to a Simplified Equation with correct MLRs. The most difficult process of this system is to determine whether a logical relationship is correct through the Layered Logic Compiler Proof Checker, implemented as an Advanced Object-Oriented Prolog mathematical logical relationship proof checking language construct.

The New Mathematical Object, Einstein's Unified Field Theory, Drawing 3, FIG. 35, has distinct components, C[1] . . . C[p] that is described in an Atomic-Domain-MLR representation, FIG. 36, with an example for one component C[k]: a Unified Field Theory Equation and corresponding MLRs, for some value k, p∈N. The Unified Field Theory has never been correctly formulated by any other scientist after Einstein, and the development of this system for research and development has been my primary goal, such that the power of this system lies in its ability to discover new relationships between two objects, a cornerstone to automated research and design.

The Legend of Diagram Components map the components to FIGS. 1 . . . 9 of the Chaotic-Logic Artificial Neural Network MLR (Mathematical Logical Relationship) Generator presented in Drawing 4, that is responsible for formulating logic between two components A[i] and B[j] using many collaborative logic strings traversing the Definitions Space, FIG. 2, Problem Logic Space, FIG. 8, Solution Logic Space, FIG. 1, and lastly the Logic Compiler Proof Checker, FIG. 3, giving the Correct MLR to the User's Monitor, FIG. 7 for User Control and Feedback Machine Learning.

The Chaotic-Logic Artificial Neural Network MLR (Mathematical Logical Relationship) Generator presented in Drawing 4, FIG. 2, produces, by Pseudo-Random Seed and Definitions, initial logic for use in passing through the Problem Logic Space, FIG. 8, acquiring the problem or theorem to be solved, and chaotically finding the correct mathematical logical relationship when it enters the Solution Logic Space, FIG. 1. Given inserts of Logical Procedural Implications and Logic Sets with variables in the Solution Logic Space, FIG. 8, the most important feature uses a Clustered Logic Map Solution Space, Drawing 5, to map an Object A[i] component, Drawing 4, FIG. 5, and Object B[j] component, FIG. 6, forming a solution logic space map, where Logic Strings chaotically pass through it, and once it has established this, the Layered Logic Compiler Proof Checker, FIG. 3, checks then passes the Correct Logic to the User's Monitor, FIG. 7, and into the Correct Logic Database, FIG. 4, upon which the user and logic information is fed back to the Generator for Machine Learning. This System generates millions of collaborative logic strings governed by User control such that the Logic Strings cycle through the System through feedback learning, and repeatable by initial Pseudo-Random Seeds.

The Object Component A[i], FIG. 5, contains information, in Atomic-Domain-MLR, embedded in the Clustered Logic Map Solution Space, Drawing 5, such that its Advanced Object-Oriented Common Lisp construct share Groups of Logic Sets fused in a manner ordered from general to specific so as to allow Logic Strings to traverse its Logic Space. The Object Component B[j], FIG. 6, performs the same procedure as Object Component A[i], but embedded on the opposite end of the Clustered Logic Map Solution Space, Drawing 5, supporting the creation of mathematical logical relationships between the two Object Components, A[i] and B[j], FIG. 50 & FIG. 51.

The Logic Generator, Drawing 4, FIG. 2, from a Pseudo-Random Seed, creates an initial logic string to accommodate logic attachments, and modifications, when the logic string passes through the Problem Logic Space and into the Artificial Neural Network Solution Logic Space, FIG. 1. The Logic Generator consists of Pseudo-Random Seeds, for repeatability, and the Definitions Logic Space, an Advanced Object-Oriented Common Lisp language construct that defines the nature of Logic Strings. The Pseudo-Random Seed is not just a number but contains mathematical logic, an Atomic-Domain-MLR logical nucleus, so as to form more mathematics and logic around it. The Logic String, given the Pseudo-Random Seed, traverses the Definitions Logic Space, FIG. 2, in order to append Advanced Object-Oriented Common Lisp Definitions Logic Strings, which after enters the Problem Logic Space, FIG. 8.

The Problem Logic Space, FIG. 8, is the next entrance after the Logic Generator. The Logic String passes through one pathway of creating the problem to be solved that consists of Problems, for applications, or Theorems, for proofs. The Problems or Theorems Logic Space are ordered top-down, such that the Stings pass from the top to the bottom of the Problem Logic Space as shown in, FIG. 8, upon which the Logic String enters the Solution Logic Space, FIG. 1, in order to solve the problem or theorem.

The Artificial Neural Network Mathematical Logical Relationship Solution Space, FIG. 1, the most complicated, takes the Logic String from the Problem Logic Space and begins to transform, given its problem or theorem information, into a Solution Logic String, an Advanced Object-Oriented Common Lisp construct, and within it, an Advanced Object-Oriented Prolog mathematical logical relationship language construct, for the purpose of checking MLRs through the Prolog Layered Logic Compiler Proof Checker. The Sorted Logic Maps, FIG. 9, inserts, from an outside database, organized Groups of Logic Sets into the Solution Logic Space, forming a Clustered Logic Map Solution Space, Drawing 5, which can be traversed by Logic Strings.

The Layered Logic Compiler Proof Checker, FIG. 3, then, analyzes the Solution Logic String through a Layered Logic Compiler, an Advanced Object-Oriented Prolog Compiler that, if correct, sends the mathematical logical relationship answer strings to the User's Monitor, FIG. 7, and stored in the Database Logic Storage, FIG. 4, using an advanced Database Management Application, where Prolog Compiler Rules are inserted by the User.

The User's Monitor, FIG. 7, is where one can control the events of this system, write a structured requirements schema, provide design manipulation, and visual programming, using an Advanced Computer Aided Software Engineering (CASE) Tool Application, written in a popular language, with an Advanced Object-Oriented Common Lisp embedded language for visual programming applications.

The Logic Data Store, FIG. 4, is storage for Correct Logic provided by the Layered Logic Compiler Proof Checker and User Information through an Advanced Object-Oriented Database Application, such that the user controls and specifies its settings. The Feedback Learning, from the User's Monitor to the Logic Generator, provides the capability of further controlling Logic Strings and Machine Learning.

The Generalized Logic Space Sweep String S[i], Drawing 6, FIG. 38, with the ability of message collaboration, FIG. 37, is an example of Logic Strings passing through a generalized logic space, sorted by clustering Groups of Logic Sets to form a Logic Map, such that for all [x,y,z]ε\check{R}³ in Real Space, FIG. 40, the point x,y,z maps to Groups of Logic Sets. The Logic Sample Vector, FIG. 42, searches the Logic Map with the extent of the radius of a sphere centered at S[x,y,z] and its surface with variable search radius R[x,y,z], FIG. 43. The decision, FIG. 39, to move through the generalized logic space is done through the content of the Logic Sample Vector, Mathematical Logical Relationship Memory, other Strings, Predefined User Control, and Pseudo-Random Seed for repeatability, and an Artificial Neural Network Schema, FIG. 41. The Logic Space, FIG. 40, a generalized three-dimensional logic space, allows Logic Strings to traverse it such that for all x,y,z position in Real Space \check{R}³, the point x,y,z contains Groups of Logic Sets, inserted in an organized manner, to form a Logic Map, FIG. 37. The Logic Map Sweep String, FIG. 38, is the path of traversal of String S[i], and each position recorded with the Pseudo-Random Seed for the purpose of repeatability. The Logic Sample Space Vector, FIG. 42, contains points that map to Groups of Logic Sets within the Variable Search Radius, R[x,y,z], such that the Artificial Intelligence AI[i], FIG. 41, decides from the Logic Sample Vector information, the necessary path in the Clustered Logic Map Solution Space, Drawing 5. The Logic String Sphere, Drawing 6, FIG. 43, is the extent to which the surface or volume of the sphere provide information for deciding, FIG. 39, which path to traverse in the Solution Logic Space. The Artificial Intelligence AI[i], FIG. 41, is further elaborated on Drawing 7.

The Clustered Logic Map Solution Space, Drawing 5, shows a three-dimensional rendition of clustered and generalized positive and negative logic with fused logic inserts of one component A[i] and one component B[j], where the three-dimensional coordinates are, respectively, generalizations for Z, FIG. 44 & FIG. 48, fused components for X, FIG. 49, and infinity for Y, FIG. 53, such that for all x,y,z in Real Space, FIG. 54, the point x,y,z contains or maps to groups of Logic Sets, where the Logic Strings S[i] traverses the Logic Space forming mathematical logical relationships between the two Object Components A[i], FIG. 50, and B[j], FIG. 51. Negative Logic, FIG. 47, mirrors the Positive Logic, FIG. 45, clustering the Logic, FIG. 46, with its peaks as generalizations, and the x-y plane as specifications, FIG. 52.

For all [x,y,z] in \check{R}³ Real Space, FIG. 54, the point maps to Groups of Logic Sets. In order to accommodate inserts, the point x,y,z can range into decimal values so as to always have the availability of free space for inserts of Groups of Logic Sets. The three-dimensional Real Space consists of X,Y,Z coordinates respectively. The Generalizations for the Z coordinate, FIG. 44 & FIG. 48, are Groups of Logic Sets ordered such that generalized, Positive Logic Sets, FIG. 45, are at the top, while the generalized Negative Logic Sets, FIG. 47, are at the bottom, and the x-y plane, FIG. 52, z=0, contains the most specific Logic Sets. The Fused components for the X coordinate, FIG. 49, are the Two Object Components A[i], FIG. 50, and B[j], FIG. 51, that fuse by sharing the generalized three-dimensional Real Space of Groups of Logic Sets through ordering up to the y-z plane, that range from a very large negative to a very large positive value for the Y coordinate, FIG. 53. The Clustered Logic, FIG. 46, contains negative and positive generalized peaks and ordered below it by more specific Groups of Logic Sets down to the x-y plane, FIG. 52.

The Generalized Logic Space Sweep String, Drawing 6, traverses the Clustered Logic Map Solution Space in order to create a mathematical logical relationship between the two fused Object Components A[i], FIG. 50, and B[j], FIG. 51. The ordering and sorting of the Clustered Logic Map Solution Space can be done though an Advanced Database Management System that manipulates Groups of Logic Sets through the position x,y,z as its primary key, sorted by mathematical function definitions mapped to Groups of Logic Sets.

The Advanced Object-Oriented Common Lisp Logic Strings, Drawing 7, explains the relationship between the Logic Map Sample Vector, FIG. 55, with length R in one-dimensional Real Space, FIG. 57, for each position x,y,z in the Clustered Logic Map Solution Space, FIG. 58. The AI[i] Decisions, FIG. 59, direct the movement of the String S[i] in the Clustered Logic Map Solution Space, using an Artificial Neural Network Schema, FIG. 67, and information from String S[i] Memory, FIG. 56, that contains the User Control, FIG. 60, Pseudo-Random Seed, FIG. 61, Definitions, FIG. 62, Problem or Theorem, FIG. 63, A[i] component, FIG. 64, B[j] component, FIG. 65, and Mathematical Logical Relationships, FIG. 66, such that the language is an Advanced Object-Oriented Common Lisp construct, but the Mathematical Logical Relationship, FIG. 66, an Advanced Object-Oriented Prolog construct. The Logic Map Sample Vector, FIG. 55, contains points, from one-dimensional Real Space 1 . . . R, FIG. 57, that map to Groups of Logic Sets acquired from the Clustered Logic Map Solution Space, Drawing 5, positioned at x,y,z, FIG. 58, where the AI[i] Decisions, FIG. 59, an Artificial Neural Network Schema, FIG. 67, determine the next position in the Clustered Logic Map Solution Space, Drawing 5, through information from the Logic Map Sample Vector, Drawing 7, FIG. 55, and String S[i] Memory, FIG. 56, which is implemented as an Advanced Object-Oriented Common Lisp Logic String construct. The User Control, FIG. 60, contains a Lisp construct that manipulates and controls the AI[i] Decisions, FIG. 59, determining the next position N[x,y,z]. The Pseudo-Random Seed, FIG. 61, contains an Atomic-Domain-MLR logical nucleus, specified by the User, so as to form more mathematics and logic around it, and the previous P[x,y,z] path positions recorded for repeatability. The Definitions, FIG. 62, an Advanced Object-Oriented Common Lisp language construct, determines the nature of Logic String format acquired from the Definitions Logic Space, Drawing 4, FIG. 2. The Problem or Theorem, Drawing 7, FIG. 63, is the Problem or Theorem to be solved in Atomic-Domain-MLR representation. The A[i] Component, FIG. 64, and B[j] Component, FIG. 65, in an Atomic-Domain-MLR Advanced Object-Oriented Common Lisp language construct, are saved within the Logic String S[i] Memory for use of the AI[i] Decision process. The Mathematical Logical Relationships, FIG. 66, are Advanced Object-Oriented Prolog constructs, translated by the Artificial Neural Network Schema, FIG. 67, from the Logic Map Sample Vector, FIG. 55.

The Catalasan Generalization Theorem, Drawing 8, is for the purpose of the mathematical understanding of generalizations and specifications for the Clustered Logic Map Solution Space, and to explain how this system can function as an example. FIG. 68, states the notion of p implies q, or p→q, that the implication is a logical procedure sorted as a point x,y,z, in the Clustered Logic Map Solution Space, so that p (input variables)→q (output variables) happen for every notion of a proof, and all its equivalent forms, such as the contrapositive, [symbol] q (input variables)→ [symbol] p (output variables), and is the Group of Equivalent Logic Sets mentioned above. As an example, Drawing 8, in the Catalasan Generalization Theorem, there are two objects: (A₁ . . . Aₙ such that they are subsets of A, for all n belonging to N) and (there exists a belonging to A such that all the Intersections (A₁ . . . Aₙ)={a}). Given these two objects, we must find the mathematical logical relationships between them, and since the Solution Logic Map contains implication procedures, and we have all the variables for inputs and outputs of implications, this logic formulator will find, through the Chaotic-Logic Artificial Neural Network MLR Generator, the necessary mathematical logical relationship solution steps. The Groups of Logic Sets, FIG. 68, associated with the two object examples, is the Catalasan Generalization Theorem proof, shown in Drawing 8. The Catalasan Generalization Theorem, Drawing 8, states the nature of generalizations and the proof associated with it. A generalization is merely the common component within a series of sets, having the intersections of which, equal to the component. With this in mind, the clustered peaks of the Clustered Logic Map Solution Space, Drawing 5, are the common elements and logics of each Group of Logic Sets mapped to the point x,y,z in three-dimensional Real Space \check{R}³, having the z-axis as generalization z-points.

The Software Engineering Creativity System Structure, where the position of this logic formulator applies to real world applications is stated in Drawings 9, 10, and 11. The Requirements, FIG. 69, is the User's attempt to control the system through definitions which would control and configure the structure of objects, not as the usual ad hoc requirements definition but a generalized mathematical schema for the structural configuration of objects. In the Analysis, FIG. 70, the User inputs Objects and Relationships using an Advanced Computer Aided Software Engineering (CASE) Tool. The Design, FIG. 71, is the most complicated. However, there are four explicit rules as to the Automated Object Designer's will in creating an object design specified by the Requirements and Analysis: Rule 0, FIG. 72, has the ability to create a Super Object C; Rule 1, FIG. 73, has the ability to create a Left or Right Object; Rule 2, FIG. 74, has the ability to create a Super Object C, and a Left or Right Object; Rule 3, FIG. 75, has the ability to create an Aggregation Object ABC, FIG. 76, and a Super Object, and a Left or Right Object; Rule 4, FIG. 77, has the same properties as Rule 3, summarized in FIG. 78. And, lastly, the Implementation, FIG. 79, automates code generation through an Advanced Compiler that translates MLRs and Logic Strings into standard if-then-else logic.

The Requirements and Analysis are available to the User through an Advanced Object-Oriented Common Lisp Visual Programming Integrated Development Environment, an Advanced Computer Aided Software Engineering (CASE) Tool, and Advanced Computational Mathematical Applications, organized into one super-user Application called a Logic Formulator, the name I selected since it is no longer a computer.

The Requirements, FIG. 69, a generalized mathematical schema, written as a high level Advanced Object-Oriented Common Lisp language, define the Nature of Objects, its Problem Domain, and the Problem to be solved, through explicit formal User Definitions, Control, and Configuration of the System.

The Analysis, FIG. 70, requires a formal procedure and visual structure in the input of objects and relationships between them, so as the ability to control object designs, and the system's control defined by the Requirements. Moreover, automated object inserts from an outside Object-Oriented Database Management System of Objects can assist and automate the User's input of objects and their relationships.

The Design, FIG. 71, an Automated Object Designer, using information from the Requirements and Analysis, manipulates the Analysis Objects and Relationships, whether inputted by the user or automatically inputted, to solve the Problem by Automated Object Designs, that use a Database of Object Designs, and many Object Design Rules, in which, four explicit rules are stated: Rule 0, FIG. 72, has the ability to create a Super Object C; Rule 1, FIG. 73, has the ability to create a Left or Right Object; Rule 2, FIG. 74, has the ability to create a Super Object C, and a Left or Right Object; Rule 3, FIG. 75, has the ability to create an Aggregation Object ABC, FIG. 76, and a Super Object, and a Left or Right Object; Rule 4, FIG. 77, has the same properties as Rule 3, summarized in FIG. 78, so as to satisfy the Requirements defined by the User.

The Rule 0, FIG. 72, given any two objects in any system of objects, this Machine's Object Designer can create a super object from any of these pair of objects. The Rule 1, FIG. 73, given an input of one object in any system of objects, this Machine's Object Designer can create a left or right object. The Rule 2, FIG. 74, given inputs of two objects or any two objects in any system of objects, this Machine's Object Designer can create both a super object and a left or right object from any of these two objects. The Rule 3, FIG. 75, given inputs of three objects or any three objects in any system of objects, this Machine's Object Designer can create a super object, a left or right object, or aggregation super object consisting of any three lower objects. The Rule 4, FIG. 77, follows the Rule 3, FIG. 75. The Four Explicit Rules Summarized, FIG. 78, shows the object patterns for Rules: 0, 1, 2, and 3. A very important property of Rule 3, FIG. 75, an aggregation of objects, provides induction capabilities, since the aggregation super object contains common attributes and relationships between the three or more objects.

The Implementation, FIG. 79, an Advanced Implementation Compiler that translates MLRs and Logic Strings from the Advanced Object-Oriented Prolog Compiler Proof Checker, automates programming by using MLR standard if-then-else, etc . . . logic, instead of Proofs, and Objects, which consist of attributes and methods, should now compose of attribute-MLRs and MLRmethods( ), so as to conform to modern Object-Oriented Analysis & Design Theory. The Conversion of the Logic Strings into an Algorithm provides the capability of automated programming through Mathematical Logical Relationship Generation and Conversion into an Advanced Object-Oriented Common Lisp programming language algorithm.

The Total Conglomeration of this System, since I have only specified One Component, A[i], of an Object to be mapped to One Component, B[j], of an Object, there must be a simultaneous mapping of All Components through the use of Parallel Architectures and Multiprocessors. And, more importantly, is this Logic Formulator's Ability to Design as well, since it can create a New Object from Two Old Distinct Objects. However, in order to Design, this formulator requires the appropriate injection and initial input of Objects, which is quite similar to Human Learning and Design, in that we learn by inserting objects and design by manipulating these inserted objects. Similar to imagination, a Chaotic-Logic Artificial Neural Network MLR Generator, and human neural networks, an Artificial Neural Network Schema for Decisions in a Clustered Logic Map Solution Space, provide this Logic Formulator with creative abilities almost equal and perhaps greater than creative human thought processes. The very essence of two Objects, Chaos and Logic, respectively, finding relationships between them, is exactly what this Logic Formulator accomplishes, which is a Chaotic-Logic Mathematical Logical Relationship Generator between Two Distinct Mathematical Objects, therefore, implemented through Advanced Object-Oriented Analysis & Design, we can use a formulator to feedback on it's design to further improve itself.

1. New Mathematics Generation from any two distinct Mathematical Objects, that is represented in an Atomic-Domain-Mathematical Logical Relationship and inputted automatically by an Advanced Object-Oriented Database Management System and/or manually by a User through an Advanced Computer Aided Software Engineering (CASE) Tool with an Advanced Visual Object-Oriented Common Lisp Integrated Development Environment so as to provide visual and graphical mathematical language representation capabilities, creates Mathematical Logical Relationships between the two Mathematical Objects by a Chaotic-Logic Artificial Neural Network MLR Generator which uses millions of Logic Strings in an Advanced Object-Oriented Common Lisp construct such that each String is initialized by a Pseudo-Random Seed for Repeatability, and that contains the Repeatable Pseudo-Random Seed and Clustered Logic Map Space Positions, Definition, Problem, in Advanced Object-Oriented Common Lisp constructs, and Mathematical Logical Relationships Solution in Advanced Object-Oriented Prolog constructs, acquiring each information mentioned above by passing through the Clustered Definitions Logic Map Space, Clustered Problem Logic Map Space, Clustered Solution Logic Map Space, where the Groups of Logic Sets are inserted from an outside Advanced Object-Oriented Management Database System sorted by mathematical function definitions into each Logic Map Space mentioned above, and MLR in an Advanced Object-Oriented Prolog construct checked by the Advanced Object-Oriented Prolog Compiler, being the decision for directions within the Clustered Logic Map Space mentioned above governed by an Artificial Neural Network Schema, repeating this for all Object Components, through parallel architectures and multiprocessors, with Machine and User Feedback Learning from User and Advanced Object-Oriented Correct Logic Mathematical Logical Relationships Database Management System information, produces a new Mathematical Object in Atomic-Domain-Mathematical Logical Relationships simplified by an Advanced Computational Mathematics Application.

2. The same as claim 1, with Automated Design of any Application, given the Configuration of the Logic Formulator, Pre-defined User Control, Problem Domain, Problems to be Solved, and a Formal Structured Requirements Definition Schema, all in an Advanced Object-Oriented Common Lisp construct called the Requirements Definition, and the Application's input of all Objects and their Relationships such that the Objects are generalized rather than purely Mathematical Objects inputted automatically by an Advanced Object-Oriented Database Management System and/or manually by a User through an Advanced Computer Aided Software Engineering (CASE) Tool called the Application's Analysis, allows the Automated Object Designer, using an Advanced Object-Oriented Database Management System containing heuristic Object Designs with Design Rules in order to Map and Manipulate Objects governed by the Formal Structured Requirements Definition Schema mentioned above, implemented such that a New Object created come from claim 1, to formulate New Objects and/or Relationships between New or Old Objects of Designs with many Design Rules of which four are explicit: Creation of Super Object, Creation of Left or Right Objects, and Creation of Aggregation Objects, so as to form an Object Design Structure satisfying the Requirements Definition and the Application's Analysis mentioned above, in order to solve the Problems acquired by the Clustered Problems Logic Map Space within the Problem Domain specified by the User.

3. The same as claims 1 and 2, with Automated Research of any Application, given any unknown knowledge, separated into distinct Mathematical Objects by an Advanced Computational Mathematics Application and inputted automatically by an Advanced Object-Oriented Database Management System and/or manually by a User through an Advanced Computer Aided Software Engineering (CASE) Tool, finds Mathematical Logical Relationships between the Mathematical Objects so as to create entirely New Mathematical Objects different from the Previous Mathematical Objects by generating MLRs to New or Old Mathematical Objects in order to expand and search for further Mathematical Objects with the ability of Mathematical Induction, which is a creation of Super Aggregation Objects from three or more Mathematical Objects through the formation of sub-level steps of Super Objects building up to form Super Aggregation Objects controlled by the User through Formal Structured Requirements Definition Schemas mentioned above in claims 1 and 2.

4. The same as claims 1 and 2, with Automated Programming, using the Object Design of the Application, and instead of Logic Proofs, uses standard if-then-else . . . logic of Logical Implication Procedures in Groups of Logic Sets within the Clustered Logic Map Spaces as mentioned above in claims 1 and 2, creates Programming Logic between Mathematical Objects by incorporating Mathematical Logical Relationships from the Advanced Object-Oriented Correct Logic Database Management System such that the Advanced Object-Oriented Common Lisp Implementation Compiler uses the MLR Programming Logic and its Objects as its Rules and Design, respectively, to automatically generate code into an Advanced Object-Oriented Common Lisp language algorithm.

5. The same as claims 1, 2, 3, and 4, with Robotic & Artificial Intelligence Evolution by Feedback Design, given the Object-Oriented Design Structure of this Logic Formulator, applying New Mathematics Generation of Chaos and Logic Mathematical Objects, Automated Design of this Logic Formulator Application, Automated Research of this Logic Formulator Application, and Automated Programming of this Logic Formulator, mentioned in claims 1, 2, 3, and 4, produces a further improved Logic Formulator governed by the User or another Logic Formulator.
